(19) United States
(12) Patent Application Publication
(10) Pub. No.: US 2020/0384960 A1
(43) Pub. Date: Dec. 10, 2020

(54) METHOD FOR OPERATING A VEHICLE WASHING SYSTEM

(71) Applicant: Washtec Holding GmbH, Augsburg (DE)

(72) Inventor: Stefan Mayer, Neusaess (DE)

(21) Appl. No.: 17/000,190

(22) Filed: Aug. 21, 2020

Related U.S. Application Data
(63) Continuation of application No. PCT/EP2019/053948, filed on Feb. 18, 2019.

(30) Foreign Application Priority Data
Feb. 21, 2018 (DE) 10 2018 103 832.1

(51) Int. Cl. B60S 3/04; G06K 7/14; G06K 7/10; H04W 4/80; G06Q 10/00

(52) U.S. Cl. CPC B60S 3/04; G06K 7/1404; G06Q 10/20; G06K 7/10396; H04W 4/80; G06K 7/10386

(57) ABSTRACT

A method of operating a vehicle washing facility includes optically scanning a code including washing detergent data on a transport container of a washing detergent with a portable device, converting the washing detergent data into control data for the vehicle washer; and controlling the vehicle washer based on the control data.

### CROSS REFERENCE TO RELATED APPLICATIONS

This application is a continuation application of international patent application PCT/EP2019/053948, filed Feb. 18, 2019, designating the United States and claiming priority to German application 10 2018 103 832.1, filed Feb. 21, 2018, and the entire content of both applications is incorporated herein by reference.

### TECHNICAL FIELD

The present disclosure relates to a method of operating a vehicle washing installation, a vehicle washing installation system, and a vehicle washing installation.

### BACKGROUND

Existing systems for detecting chemicals on interchangeable canisters have proven to be disadvantageous, as special containers are used, resulting in a self-contained system. A user guidance based on washing substance data and an automatic transfer of settings into the machine is not yet known.

The document DE 10 2006 022 477 describes a cartridge for insertion into a receptacle of a vehicle treatment device.

### SUMMARY

It is an object of the present disclosure to simplify the operation of a vehicle washing system.

The object is achieved by a method for operating a vehicle washer, a vehicle washing system, and a vehicle washer as described herein.

According to a first aspect, the method for operating a vehicle washer or washing installation includes the steps of optically scanning a code including washing detergent data on a transport container of a washing detergent with a portable device, converting the washing detergent data into control data for the vehicle washer, and controlling the vehicle washer based on the control data.

The car wash is used for the automatic washing of motor vehicles, such as cars, trucks or buses. The washing process is carried out, for example, with rotating brushes based on control data. The technical advantage of the specified process is that the vehicle washing installation can be automatically adapted to the washing detergent in the transport container.

The transport container is a container used to transport the washing detergent. In one case, the transport container may be provided as an interchangeable container from which the washing substance is removed with a suction lance and fed directly to the vehicle washing installation. In another case, the transport container is used to manually fill a storage container for the washing substance, which is an integral part of the vehicle washing installation.

The optical code on the transport container is an optically readable code, such as a barcode or QR code. The washing detergent data is data specific to the particular washing detergent in the transport container, such as an article number and/or a web address to an online database from which further information can be retrieved. In general, however, further information may also be provided in the washing detergent data.

The control data is used to control the vehicle washing system, for example during a wash or refill operation. The conversion of the washing data into control data is carried out by an electronic conversion device, which can be formed, for example, by a program on the portable device, a program on a remote server with an online database, or a program within the vehicle washing system. However, the conversion device may also be a hard-wired electronic circuit. Washing detergent data are entered into the conversion device. The control data associated with the washing detergent data are then output by the conversion device, for example with an electronic look-up table. In general, the conversion device may be provided at any one or several distributed locations as long as direct or indirect data communication with the portable device and/or the vehicle washing system is possible.

In a technically advantageous version of the method, the portable device is a mobile phone, a tablet PC or augmented reality glasses. The mobile phone or tablet PC includes an application (app) or cloud application that can be used to access the camera of the mobile phone or tablet PC to scan the code. This has the technical advantage, for example, that the washing detergent data can be easily captured and transmitted using standard communication devices. The augmented reality glasses are glasses with an integrated micro display and a camera, so that the user can be shown further information about the environment. The augmented reality glasses can visually highlight vehicle wash components that are to be operated or handled when the washing detergent is filled in.

In another technically advantageous version of the process, the washing detergent data are transmitted wirelessly from the portable device via a radio interface. This has the technical advantage, for example, that there is no need for corrosion-prone cables and mechanical connections to transmit the washing detergent data.

In another technically advantageous version of the method, the radio interface is a WLAN interface or a Bluetooth interface. This provides the technical advantage, for example, that data can be transmitted efficiently and quickly.

In a further technically advantageous version of the method, the washing detergent data are converted into control data for a dosing pump to deliver the washing detergent. Depending on the design of the vehicle washing system, the washing detergent can be delivered from the transport container or the storage container within the vehicle washing system. The control data are forwarded to the dosing pump in the vehicle washing system so that the dosing pump can use a designated dosing setting. This has the technical advantage, for example, that the metering pump can be controlled specifically depending on the washing detergent.

In another technically advantageous version of the method, the flow rate of the dosing pump is controlled on the basis of the control data. This has the technical advantage, for example, that a suitable flow rate can be set depending on the washing substance.

In another technically advantageous version of the method, the washing detergent data are converted into control data for issuing a warning on the portable device if an expiration date of the washing detergent is exceeded. This has the technical advantage, for example, that the use of expired washing detergent can be prevented. When using the transport container as a swap a detergents container, operation of the vehicle washing system can also be blocked if the expiration date has been exceeded.

In another technically advantageous version of the method, the washing substance data include a web address to an online database. This has the technical advantage, for example, that additional and more extensive washing substance data or control data can be called up.

In another technically advantageous version of the method, the remaining washing detergent data, such as an article number, are transferred to the online database. The transfer to the online database can be carried out by the portable device or the vehicle washer. The portable device or vehicle washer shall be equipped with an Internet interface for this purpose. This has the technical advantage, for example, that further washing detergent data or control data can be made available directly or indirectly.

In another technically advantageous version of the method, the washing detergent data is converted into control data for displaying user information for handling the transport container. This has the technical advantage, for example, that correct handling of the washing detergent by the user can be achieved. If, for example, the transport container is used as a swap a detergents container, the portable device can display how the old transport container, which in this case also serves as a storage container for the vehicle washing system, can be replaced by the new one. For this purpose, the necessary operating steps can be displayed on the portable unit. However, if, for example, the transport container is used to refill a fixed reservoir, it is possible to display where the reservoir for the washing detergent is located within the vehicle washing system. The necessary operations can also be displayed on the portable unit.

In another technically advantageous version of the method, the washing detergent data are converted into control data for carrying out a rinsing procedure for automatically rinsing a dosing system for the washing detergent if the washing detergent is changed. If, for example, it is determined from the washing detergent data that a newly added washing detergent differs from a previously provided washing detergent, the rinsing procedure is carried out or initiated on the basis of the control data. In this way, it can be prevented that the newly added washing detergent and the previously provided washing detergent mix unintentionally.

If the transport container is used as a swap body as described above, another container with water is provided before the new transport container is used. The rinsing procedure for the dosing system is carried out automatically after the water container has been provided if it is detected that a different washing detergent than the previous one is to be used. If, on the other hand, the transport container is used to refill a storage container, as described above, the fixed storage container can be filled with water first. The rinsing procedure for the dosing system is carried out automatically after filling the storage container with water if it is detected that a different washing detergent than the previous one is to be used. In both cases, any manual operating steps that may be required can be displayed on the handheld unit.

In another technically advantageous version of the method, the washing detergent data are converted into control data for controlling a mechanical cleaning system. The control data can, for example, determine a washing program or control a washing duration or a rotational speed of the brushes. This results in the technical advantage, for example, that depending on the washing detergent, the vehicle can be cleaned mechanically according to the specific washing detergent.

According to a second aspect, the task is solved by a vehicle washing system, including a vehicle washing installation having a control apparatus for controlling the vehicle washing installation based on control data, a portable apparatus for optically scanning a code including washing detergent data on a transport container of a washing detergent, and converting means for converting the washing detergent data into control data for the vehicle washing system. The vehicle washings system provides the same technical advantages as the method according to the first aspect.

According to a third aspect, the object is achieved by a vehicle washing installation, with an electronic data interface to receive data; and a control unit to control the vehicle washing installation based on the received data. The data can be, for example, washing detergent data, which are converted into the control data within the vehicle washing system with the conversion device. However, the data can also be control data that can be used directly by the vehicle washing system.

### BRIEF DESCRIPTION OF THE DRAWINGS

The disclosure will now be described with reference to the drawings wherein:

FIG. 1 is schematic diagram of a vehicle washing installation according to an exemplary embodiment of the disclosure; and

FIG. 2 shows a block diagram of a method for operating a vehicle washing system.

### DESCRIPTION OF EXEMPLARY EMBODIMENTS

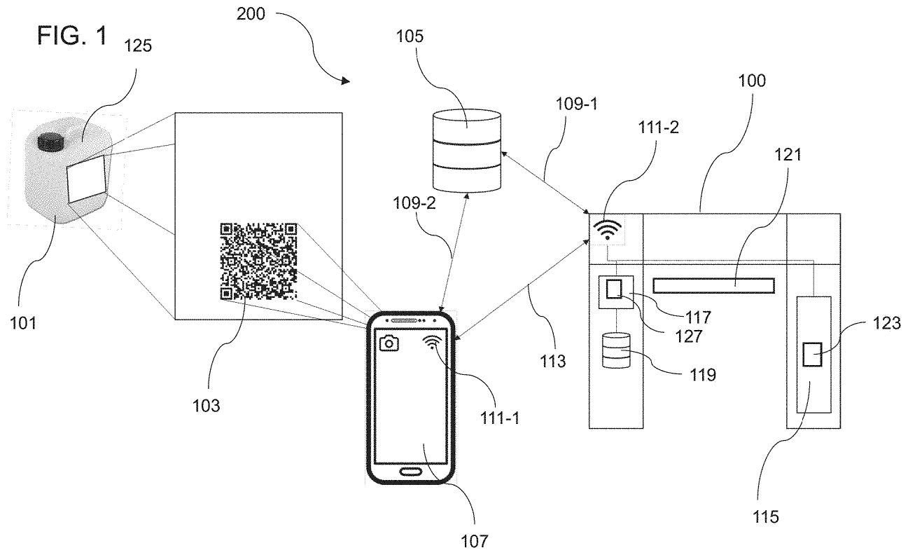

FIG. 1 shows a schematic diagram of a vehicle washing system 200 with a vehicle washer 100. The vehicle washer 100 is used for the automatic cleaning of vehicles, such as cars or trucks. The cleaning process is carried out mechanically with rotating brushes using water and other liquid, chemical washing substances, such as cleaning or care substances. For this purpose, the vehicle washer 100 is controlled electronically by a control unit 117 using control data.

The washing substance 125 for the cleaning process is provided in a portable transport container 101 and is fed from there to the vehicle washer 100. This can be done directly by hanging a suction lance in the transport container 101 and feeding the washing substance 125 to the vehicle washer 100 from the transport container 101 during the cleaning process. In this case the transport container 101 also serves as a storage container. However, this can also be done indirectly by first filling a storage container 123, which is provided in the vehicle washer 100, with the washing substance 125 from the portable transport container 101.

The transport container 101 includes an optically scannable code 103, such as a barcode or a two-dimensional QR code (Quick Response Code). The QR code can be subjected to automatic error correction, so that scanning the code 103 is robust and error-tolerant. For example, Code 103 can be printed on the transport container 101 or attached with a label.

The code 103 applied to the transport container 101 is machine-readable and includes as detergent substance data, for example, information about an article number, a chemical identification, a product name, a type of chemical, a production date, a shelf life, a standard dosage, a dosage range, a dosage setting, a product batch, a hyperlink and/or a URL (Uniform Resource Locator) to an online database 105 from which further data can be retrieved. In addition, code 103 may include a web address where further information is available to the user, such as a safety data sheet, application notes, hazard warnings or promotional material.

The online database 105 is a database that can be accessed via the provided hyperlink or URL (Uniform Resource Locator) on the Internet. With an article or identification number of the transport container 101 embedded in the code 103, it is possible, for example, to retrieve data on the washing substance 125 and its properties and application from the online database 105. It is also possible to transfer the washing substance data to the online database 105, where it is converted into control data for the vehicle washer 100 and transferred to the vehicle washer 100.

The online database 105 can be accessed either directly by the vehicle washer 100 via data link 109-1 or indirectly by a portable code 103 scanning device via data link 109-2. The online database 105 can also be used to provide additional data via the web address, such as logos or advertising material for advertisements on a control unit or batch-dependent correction factors.

The code 103 on the transport container 101 is scanned and read by the portable device 107, such as a mobile phone, smartphone, tablet PC or augmented reality glasses. For this purpose, the portable device 107 includes an electronic camera with which the code 103 can be captured with an image. The portable device 107 can then process the captured image to obtain the data on the detergent 125 in the transport container 101. In addition, by connecting to the vehicle washer 100, the portable device 107 can output machine- or washing-substance-specific user instructions, such as animations, images or text, which can be retrieved via an Internet interface using an Internet address.

The data on the washing substance 125 can then be transferred electronically from the portable device 107 to the vehicle washer 100. For this purpose, both the portable unit 107 and the vehicle washer 100 have a corresponding data interface 111-1 and 111-2. A communication link 113 is established between the portable device 107 and the vehicle washer 100 via the two data interfaces 111-1 and 111-2. The data interfaces 111-1 and 111-2 are formed by corresponding electronic circuits.

The data interfaces 111-1 and 111-2 are for example wireless radio interfaces, such as WLAN interfaces or Bluetooth interfaces. This means that information about the vehicle washer 100 and the washing substance 125 used can be combined and exchanged quickly and efficiently. Compared to the portable device 107, the vehicle washer 100 can identify itself via radio. In this case, the vehicle washer 100 is automatically recognized by the portable device 107.

The code 103 of the detergent substance data, such as an article number (EAN number), can be scanned or recorded as such with the portable device 107. Subsequently, the detergent substance data or the code 103 can also be transmitted to the online database 105 via data connection 109-2, such as mobile radio or WLAN. A push message is then sent from the database application of the online database 105 to the vehicle washer 100 via data connection 109-1 together with the other washing substance data or control data. In general, the washing substance data can be transmitted via different communication paths and converted into the control data at different points.

For a larger group of users, indirect access to the vehicle washer 100 via the detour of the online database 105 is associated with higher network security, easier to set up and more compatible with the equipment.

By digitally transferring data to the vehicle washer 100 about the washing substance 125 to be refilled or assigned control data, automatic processes can be initiated in the vehicle washer 100 based on the washing detergent data or condition-specific instructions can be given. For this purpose, the vehicle washer 100 includes an electronic control unit 117 with a local data memory 119. The control unit 117 can control the respective functions of the vehicle washer 100, such as a dosing pump or a mechanical cleaning system 121 for the vehicle. For this purpose, the control unit 117 may include a microprocessor which processes the data on the washing detergent or the control data.

The control unit 117 includes for example the conversion device 127, which can be implemented as a hardware or software module. The conversion device 127 determines the required control data for the washing detergent data. For example, control data for the dosing system are obtained from the article number of the washing detergent data. For this purpose, an internally stored supplement table or the online database 105 can be accessed. In general, the conversion of the washing detergent data into control data can also be carried out elsewhere or by a multi-stage process.

For example, the mechanical cleaning system 121 includes one or more brushes that clean the vehicle using washing substance 125. In general, the control unit 117 can control or regulate all the functions of the vehicle washer 100 on the basis of the control data. For this purpose, the vehicle washer 100 also includes appropriate sensors. Depending on the washing detergent data determined, machine-specific interactive instructions can also be called up from the online database 105. In this case, a media system 115 is controlled on the basis of the washing detergent data. The media system 115 includes a storage container 123 for internal provision of washing and care products, dosing pumps, a valve system and a compressed air system.

If, for example, a new washing substance 125 is provided to replace another washing substance 125 in the vehicle washing system, this can be detected by the transport container 101 on the basis of the washing detergent data transmitted. For this purpose, the transmitted washing detergent data are compared by the control unit 117 with those of the existing washing detergent 125. If the first and the second washing detergent differ, a dosing system for supplying the washing detergent 125 is rinsed before operation with the second washing detergent. This has the technical advantage that the two washing detergents do not mix unintentionally.

In the case of a swap container system, the user can be instructed to first replace the current transport container 101 in the vehicle washer 100 with a container that is filled with water. Once this has been done, the vehicle washer 100 automatically rinses the pump and the dosing system pipes used with the water provided and then instructs the user to connect the new transport container 101 to the vehicle washer 100. Communication with the user is via the portable unit 107, on which all the necessary operating steps are displayed.

If, on the other hand, the vehicle washer 100 includes a fixed reservoir 123 for the washing detergent, this reservoir can first be filled with water. Once this has been done, the vehicle washer 100 automatically rinses the pump and the dosing system pipes with the water provided and then asks the user to fill reservoir 123 with the new washing detergent 125 from transport container 101. Here too, communication with the user is via the portable unit 107, on which all the necessary operating steps are displayed.

If the user confirms that the filling of the storage container 123 with the washing detergent 125 from the transport container 101 has been completed or the new transport container 101 is connected to the vehicle washer 100, or if this is automatically detected by the vehicle washer 100, the washing substance 125 is automatically pumped up to an injection point to make the vehicle washing system 100 ready for operation.

If the first washing substance 125 corresponds to the second washing detergent, no rinsing process is performed. This has the technical advantage that handling is simplified during refilling and the washing detergent 125 can be changed safely. The vehicle washer 100 then instructs the user, for example, to fill the reservoir 123 without any further rinsing procedure. For this purpose, the portable device 107 can be used to give the user appropriate instructions, for example by displaying pictures or videos.

If a washing substance 125 from the transport container 101 is to be filled into a fixed storage container 123 from a plurality of possible existing storage containers 123, the correct storage container 123 and its position within the vehicle washer 100 can be determined and displayed on the basis of the washing detergent data. For this purpose, data on a machine type can be transmitted from the vehicle washer 100 to the portable device 107. The portable device 107 can then determine which storage container 123 is suitable for the washing detergent 125 and where it is located within the vehicle washer 100 on the basis of the machine type and the washing detergent data by querying the online database 105. In another version, machine instructions can also be transmitted directly from the vehicle washer 100 to the portable device 107. After filling, the system can also be automatically bled.

Thus, when the detergent data are transferred, instructions for refilling existing detergent substances or any other appropriate information can be displayed on the portable device 107.

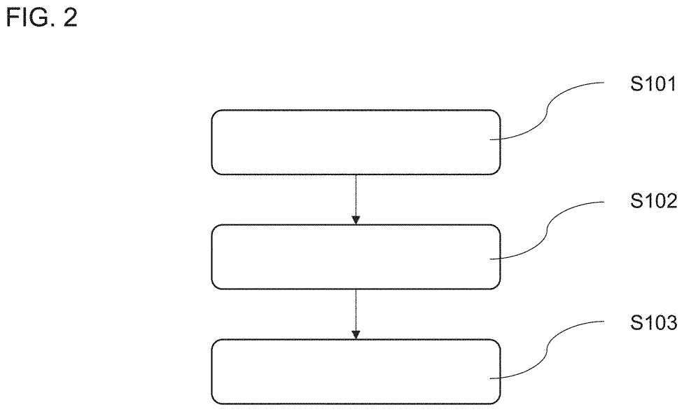

FIG. 2 shows a block diagram of the advantageous procedure for operating the vehicle washing system. In a first step S101, the code 103, which comprises the washing detergent data, is optically scanned and recorded on the transport container 101 of the washing detergent 125 with the portable device 107. The washing detergent data are then extracted from the code 103, for example by automatic image recognition. The washing detergent data can then be sent to the vehicle washer 100 or the online database 105.

Subsequently, in step S102, the extracted washing detergent data are converted into control data for the vehicle washer 100. This conversion can take place at various suitable locations using the electronic conversion device 127, such as in the portable device 107, in the vehicle washer 100 or on the server with the online database 105.

Then in step S103 the vehicle washer 100 is controlled by the electronic control unit 117 on the basis of the control data. This includes all measures that affect electronic or mechanical functions of the vehicle washer 100. For example, depending on the washing detergent 125 used, a wash program can be selected automatically, or a dosing pump can be controlled.

This means that the vehicle washer 100 can be quickly and efficiently adapted to the washing detergent 125 used. Functions and settings of the vehicle washer 100 can be easily changed depending on the washing detergent 125 by the electronic control unit 117 using the specifically determined control data. The washing detergent data can also be transferred to the vehicle washer 100 and stored in the electronic control unit 117 so that the washing detergent data can also be used at a later date.

All features explained and shown in connection with exemplary embodiments of the disclosure may be provided in different combinations in the subject-matter of the disclosure in order to realize their beneficial effects at the same time.

All process steps can be implemented with devices which are suitable for carrying out the respective process step. All functions that are carried out by physical features can be a process step of a process.

The scope of protection of the present disclosure is given by the claims and is not limited by the features explained in the description or shown to the figures.

### LIST OF REFERENCE NUMERALS

100 vehicle washer
101 Transport containers
103 optical code
105 Online database
107 portable device
109 Data connection
111 Data interfaces
113 Communication connection
115 Media system
117 Control unit
119 Data memory
121 Cleaning system
123 Reservoir tank
125 Washing detergent
127 Conversion device
200 Vehicle washing system
S101 Process step
S102 Process step
S103 Process step

What is claimed is:

1. A method for operating a vehicle washer, the method comprising:
optically scanning a code comprising washing detergent data on a transport container of a washing detergent with a portable device;
converting the washing detergent data into control data for the vehicle washer; and
controlling the vehicle washer based on the control data.

2. The method according to claim 1, wherein the portable device is a mobile telephone, a tablet PC, or augmented reality glasses.

3. The method according to claim 1, wherein the washing detergent data is wirelessly transmitted from the portable device over a radio interface.

4. The method according to claim 3, wherein the radio interface is a WLAN interface or a Bluetooth interface.

5. The method according to claim 1, wherein the washing detergent data is converted into control data for a dosing pump for delivering the washing substance.

6. The method according to claim 5, wherein the flow rate of the dosing pump is controlled based on the control data.

7. The method according to claim 1, wherein the washing detergent data is converted into control data for issuing a warning on the portable device if an expiration date of the washing detergent is exceeded.

8. The method according to claim 1, wherein the washing detergent data includes a web address to an online database.

9. The method according to claim 8, wherein the remaining washing detergent data is transferred to the online database.

10. The method according to claim 1, wherein the washing detergent data is converted into control data for displaying user information for a handling of the transport container.

11. The method according to claim 1, wherein the washing detergent data is converted into control data for performing a rinse procedure for automatically rinsing a dosing system for the washing detergent if the washing detergent is changed.

12. The method according to claim 1, wherein the washing detergent data is converted into control data for controlling a mechanical cleaning system.

13. A vehicle washing system comprising:
a vehicle washer with a control unit for controlling the vehicle washer based on control data;
a portable device for optically scanning a code comprising washing detergent data on a transport container of a washing detergent; and
converting means for converting the washing detergent data into control data for the vehicle washer.

14. A vehicle washer comprising:
an electronic data interface for receiving data; and
a control unit for controlling the vehicle washer based on the received data.
